(19) United States
(12) Patent Application Publication
(10) Pub. No.: US 2025/0131304 A1
(43) Pub. Date: Apr. 24, 2025

(54) REMOTE ENTANGLEMENT OF SUPERCONDUCTING QUANTUM BITS USING DOUBLE OPTICAL HERALDING

(71) Applicant: International Business Machines Corporation, Armonk, NY (US)

(72) Inventors: Abram L Falk, Port Chester, NY (US); Jason S. Orcutt, Katonah, NY (US); Timothy Phung, Milpitas, CA (US); Chi Xiong, Yorktown Heights, NY (US)

(21) Appl. No.: 18/491,583

(22) Filed: Oct. 20, 2023

(51) Int. Cl. G06N 10/40

(52) U.S. Cl. CPC G06N 10/40

(57) ABSTRACT

Techniques are provided for performing an optically heralded entanglement process to entangle states of a first data quantum bit and a second data quantum bit into an entangled state of computational basis states comprising a ground state and a first excited state. An optically heralded entanglement process comprises performing a first optically heralded entanglement process to determine whether the entangled state of the first data quantum bit and the second data quantum bit excludes a state in which both the first data quantum bit and the second data quantum bit can be in the ground state, and performing a second optically heralded entanglement process to determine whether the entangled state of the first data quantum bit and the second data quantum bit excludes a state in which both the first data quantum bit and the second data quantum bit can be in the first excited state.

### BACKGROUND

This disclosure relates generally to quantum computing and, in particular, to techniques for enabling remote entanglement of superconducting quantum bits. As is known in the art, quantum computing provides a computing paradigm which utilizes fundamental principles of quantum mechanics to perform computations. A quantum computing system can be implemented using superconducting circuit quantum electrodynamics (cQED) architectures that are constructed using quantum circuit components such as, e.g., superconducting quantum bits and other types of superconducting quantum devices that are controlled using microwave and/or flux bias control signals. In general, superconducting quantum bits (qubits) are electronic circuits which are implemented using components such as superconducting tunnel junctions (e.g., Josephson junctions), superconducting quantum interference devices (SQUIDs), inductors, and/or capacitors, etc., and which behave as quantum mechanical anharmonic (non-linear) oscillators with quantized states, when cooled to cryogenic temperatures. A qubit can be effectively operated as a two-level system in a computational subspace comprising a ground state |0 [symbol] and a first excited state |1 [symbol] of the qubit, due to the anharmonicity imparted by a non-linear inductor element (e.g., Josephson junction inductance) of the qubit, which allows the ground and the first excited states to be uniquely addressed at a transition frequency of the qubit, without significantly disturbing higher excited states of the qubit (e.g., |2 [symbol] , |3 [symbol] etc.).

Various types of quantum information processing algorithms can be implemented using a superconducting quantum processor which comprises multiple superconducting qubits which can be coherently controlled, placed into quantum superposition states, exhibit quantum interference effects, and become entangled with one another, by applying various types of quantum gate operations (e.g., single-qubit gate operations, two-qubit gate operations, etc.) to the superconducting qubits. For many applications, quantum entanglement between remote superconducting qubits is desirable to enable quantum information processing and communication between separate superconducting quantum computers that are remotely disposed over a quantum network. For various applications such as long-distance quantum communications, cryptograph, and quantum networks, remote entanglement between superconducting qubits must be heralded using, e.g., optical heralding. Indeed, since the energy of a microwave photon is less than the thermal background energy of room temperature, room-temperature quantum information links at microwave frequencies would be either extremely challenging or impossible. On the other hand, while optical photons such as infrared photons can travel long distances in optical fibers without attenuation or interference, the ability to implement remote entanglement of superconducting qubits using optical heralding is not trivial.

### SUMMARY

Exemplary embodiments of the disclosure include systems and methods for implementing double optical heralding for remote entanglement of quantum bits. For example, an exemplary embodiment includes a method which comprises performing an optically heralded entanglement process to entangle states of a first data quantum bit and a second data quantum bit into an entangled state of computational basis states comprising a ground state and a first excited state. The optically heralded entanglement process comprises: performing a first optically heralded entanglement process to determine whether the entangled state of the first data quantum bit and the second data quantum bit excludes a state in which both the first data quantum bit and the second data quantum bit can be in the ground state; and performing a second optically heralded entanglement process to determine whether the entangled state of the first data quantum bit and the second data quantum bit excludes a state in which both the first data quantum bit and the second data quantum bit can be in the first excited state.

Advantageously, a double optical heralding process is configured to exclude all possible quantum states that are not a part of a desired entangled state (e.g., maximally entangled Bell state). For example, when the product of two superposition states of two superconducting data qubits is the sum of the |0 [symbol] |1 [symbol] , |1 [symbol] |0 [symbol] , |0 [symbol] |0 [symbol] , and |1 [symbol] |1 [symbol] states, the double optical heralding process enables exclusion of the |0 [symbol] |0 [symbol] and |1 [symbol] |1 [symbol] states from the entangled state, while ensuring that the |0 [symbol] |1 [symbol] and |1 [symbol] |0 [symbol] states are part of the entangled state (e.g., maximally entangled Bell state).

Another exemplary embodiment includes a system which comprises a first quantum system comprising a first data quantum bit, a second quantum system comprising a second data quantum bit, and a control system. The control system is configured to perform an optically heralded entanglement process to entangle states of the first data quantum bit and the second data quantum bit into an entangled state of computational basis states comprising a ground state and a first excited state. In performing the optically heralded entanglement process, the control system is configured to: perform a first optically heralded entanglement process to determine whether the entangled state of the first data quantum bit and the second data quantum bit excludes a state in which both the first data quantum bit and the second data quantum bit can be in the ground state; and perform a second optically heralded entanglement process to determine whether the entangled state of the first data quantum bit and the second data quantum bit excludes a state in which both the first data quantum bit and the second data quantum bit can be in the first excited state.

Another exemplary embodiment includes a system which comprises a first quantum system, a second quantum system, an optical beam splitter, a photon detector device, and a control system. The first quantum system comprises a first data quantum bit, a first interface quantum bit coupled to the first data quantum bit, and a first quantum transducer coupled to the first interface quantum bit. The second quantum system comprises a second data quantum bit, a second interface quantum bit coupled to the second data quantum bit, and a second quantum transducer coupled to the second interface quantum bit. The optical beam splitter comprises input ports that are optically coupled to respective output ports of the first quantum transducer and the second quantum transducer. The photon detector device is coupled to output ports of the optical beam splitter. The control system is configured to perform an optically heralded entanglement process to entangle states of the first data quantum bit and the second data quantum bit into an entangled state of computational basis states comprising a ground state and a first excited state. In performing the optically heralded entanglement process, the control system is configured to: utilize the first and second interface quantum bits, the first and second quantum transducers, the optical beam splitter, and the photon detector device to perform a first optically heralded entanglement process to determine whether the entangled state of the first data quantum bit and the second data quantum bit excludes a state in which both the first data quantum bit and the second data quantum bit can be in the ground state; and utilize the first and second interface quantum bits, the first and second quantum transducers, the optical beam splitter, and the photon detector device to perform a second optically heralded entanglement process to determine whether the entangled state of the first data quantum bit and the second data quantum bit excludes a state in which both the first data quantum bit and the second data quantum bit can be in the first excited state.

In another exemplary embodiment, as may be combined with the preceding paragraphs, an optically heralded entanglement process is configured to entangle the states of the first data quantum bit and the second data quantum bit into a maximally entangled Bell state represented by

$$\frac{1}{\sqrt{2}} ( ( \vert 1 〉 \vert 0 〉 + {e}^{i ϕ} \vert 0 〉 \vert 1 〉 ) .$$

In another exemplary embodiment, as may be combined with the preceding paragraphs, when performing the optically heralded entanglement process, a state of a first interface quantum bit is entangled with a state of the first data quantum bit, and the state of the first interface quantum bit is consumed by a first quantum transducer to generate an optical photon that represents a state of the first data quantum bit. In addition, a state of a second interface quantum bit is entangled with a state of the second data quantum bit, and the state of the second interface quantum bit is consumed by a second quantum transducer to generate an optical photon that represents a state of the second data quantum bit.

Other embodiments will be described in the following detailed description of exemplary embodiments, which is to be read in conjunction with the accompanying figures.

### BRIEF DESCRIPTION OF THE DRAWINGS

FIG. 1 schematically illustrates a quantum computing system that is configured to implement double optical heralding to enable remote entanglement of quantum bits, according to an exemplary embodiment of the disclosure.

FIG. 2A schematically illustrates a double optical heralding process for remote entanglement of quantum bits, according to an exemplary embodiment of the disclosure.

FIG. 2B schematically illustrates a double optical heralding process for remote entanglement of quantum bits, according to another exemplary embodiment of the disclosure.

FIG. 3 illustrates a flow diagram of a double optical heralding process for remote entanglement of quantum bits, according to an exemplary embodiment of the disclosure.

FIG. 4 schematically illustrates a quantum computing system that is configured to implement double optical heralding to enable remote entanglement of quantum bits, according to another exemplary embodiment of the disclosure.

FIG. 5 schematically illustrates a quantum computing system that is configured to implement double optical heralding to enable remote entanglement of quantum bits, according to another exemplary embodiment of the disclosure.

FIG. 6 schematically illustrates a quantum computing system that is configured to implement double optical heralding to enable remote entanglement of quantum bits, according to another exemplary embodiment of the disclosure.

FIG. 7 schematically illustrates an exemplary architecture of a computing node which can host the quantum computing platform of FIG. 6, according to an exemplary embodiment of the disclosure.

### DETAILED DESCRIPTION

Exemplary embodiments of the disclosure will now be described in further detail with regard to systems and methods for remote entanglement of quantum bits using double optical heralding techniques. It is to be understood that the various features shown in the accompanying drawings are schematic illustrations that are not drawn to scale. Moreover, the same or similar reference numbers are used throughout the drawings to denote the same or similar features, elements, or structures, and thus, a detailed explanation of the same or similar features, elements, or structures will not be repeated for each of the drawings. Further, the term “exemplary” as used herein means “serving as an example, instance, or illustration.” Any embodiment or design described herein as “exemplary” is not to be construed as preferred or advantageous over other embodiments or designs.

Further, it is to be understood that the phrase “configured to” as used in conjunction with a circuit, structure, element, component, or the like, performing one or more functions or otherwise providing some functionality, is intended to encompass embodiments wherein the circuit, structure, element, component, or the like, is implemented in hardware, software, and/or combinations thereof, and in implementations that comprise hardware, wherein the hardware may comprise quantum circuit elements (e.g., quantum bits, coupler circuitry, etc.), discrete circuit elements (e.g., transistors, inverters, etc.), programmable elements (e.g., application specific integrated circuit (ASIC) chips, field-programmable gate array (FPGA) chips, etc.), processing devices (e.g., central processing units (CPUs), graphics processing units (GPUs), etc.), one or more integrated circuits, and/or combinations thereof. Thus, by way of example only, when a circuit, structure, element, component, etc., is defined to be configured to provide a specific functionality, it is intended to cover, but not be limited to, embodiments where the circuit, structure, element, component, etc., is comprised of elements, processing devices, and/or integrated circuits that enable it to perform the specific functionality when in an operational state (e.g., connected or otherwise deployed in a system, powered on, receiving an input, and/or producing an output), as well as cover embodiments when the circuit, structure, element, component, etc., is in a non-operational state (e.g., not connected nor otherwise deployed in a system, not powered on, not receiving an input, and/or not producing an output) or in a partial operational state.

As noted above, quantum computing provides a computing paradigm which utilizes fundamental principles of quantum mechanics to perform computations. Quantum circuits are utilized to define complex algorithms and applications in an abstract manner, which can be executed on a quantum computer. In a quantum computer, primitive operations comprise gate operations, e.g., single-qubit gate operations, two-qubit gate operations, multi-qubit gate operations (e.g., 3 or more qubits) that are applied to qubits, to perform quantum computing operations for a given application. A quantum computing system can be implemented using a superconducting quantum processor which comprises an array of superconducting qubits, such as transmon qubits, to generate and process quantum information.

Various types of quantum information processing operations (e.g., gate operations) can be performed in which superconducting qubits can be coherently controlled, placed into quantum superposition states (via, e.g., single-gate operations), exhibit quantum interference effects, and become entangled with one another (via, e.g., entanglement gate operations). In particular, quantum superposition is quantum-mechanical phenomena in which the quantum states of one or more qubits can superposed (i.e., added together) to produce another valid quantum state, wherein such quantum state can be represented as a sum of the two or more distinct states. Further, quantum entanglement is a quantum-mechanical phenomena in which a group of two or more qubits interact in such a way that the state of one qubit becomes intertwined with the states of the other qubits, wherein the quantum state of each qubit cannot be described independently (the quantum state is given for the group of entangled qubits as a whole).

Typically, quantum computing systems are configured to process quantum information that is encoded in a computational basis (|0 [symbol] or |1 [symbol] ) of the qubits, wherein gate operations are performed using the two lowest energy levels of a qubit including a ground state |0 [symbol] and a first excited state |1 [symbol] . A single qubit can have a basis state of |0 [symbol] or |1 [symbol] , or a superposition state which comprises a linear combination of such basis states |0 [symbol] or |1 [symbol] . In addition, quantum information can be encoded through entangled basis states of multiple qubits.

As is known in the art, the state of a qubit can be graphically represented as a point on unit sphere (radius=1), which is called the Bloch sphere, with X, Y, and Z axes. The basis state |0 [symbol] (referred to as ground state) of a qubit is represented at a point (north pole) on a positive Z-axis of the Bloch sphere, while the basis state or |1 [symbol] (referred to as first excited state) of a qubit is represented at a point (south pole) on a negative Z-axis of the Bloch sphere.

A superposition state |ψ [symbol] of the qubit can be represented as a point on the Bloch sphere as follows:

$$\vert ψ 〉 = cos \frac{θ}{2} \vert 0 〉 + {e}^{i ϕ} sin \frac{θ}{2} \vert 1 〉 ,$$

where the terms

$$cos \frac{θ}{2} and sin \frac{θ}{2}$$

correspond to the amplitude probabilities associated with the respective states |0 [symbol] and |1 [symbol] , and wherein the term e^{iϕ} corresponds to a relative phase between the states |0 [symbol] and |1 [symbol] . The position of a point on the Bloch sphere representing a superposition state of a qubit is determined based on the angles θ and ϕ. The angle θ represents the angle from the positive Z axis (the |0 [symbol] state) to the positive X axis on the X-Z plane, where 0≤0≤π. The angle ϕ represents the angle from the positive X axis (the |+ [symbol] state) to the positive Y axis on the X-Y plane, where 0≤¢≤2n. The angle θ influences the probability of observing a qubit state of |0 [symbol] or |1 [symbol] when the qubit is read, wherein the probability of reading a qubit state of |1 [symbol] increases as θ increases. The angle ϕ influences the relative phase between the states |0 [symbol] and |1 [symbol] . The state of a given qubit can be changed by applying a single-qubit gate operation to the given qubit, which causes the current state of the qubit to rotate around, e.g., the X-axis, Y-axis, and/or Z-axis, etc., depending on the given gate operation. A rotation about the Z-axis results in a change in the angle ϕ.

Exemplary embodiments of the disclosure include techniques for remote entanglement of superconducting qubits where remote entanglement is heralded by photon interference and detection. In particular, exemplary embodiments of the disclosure implement double optical heralding entanglement processes that are configured to entangle a pair of remote qubits (e.g., Q0 and Q2) in a maximally entangled Bell state represented as:

$$\vert ψ 〉 = \frac{1}{\sqrt{2}} \text{(\textbar} 1 {〉}_{Q 0} \vert 0 {〉}_{Q 2} \pm \vert 0 {〉}_{Q 2} \vert 1 {〉}_{Q 0} \text{)\textbar} ψ 〉 or \vert ψ 〉 = \frac{1}{\sqrt{2}} \text{(\textbar} 1 {〉}_{Q 0} \vert 0 {〉}_{Q 2} + {e}^{i ϕ} \vert 0 {〉}_{Q 2} \vert 1 {〉}_{Q 0} ) .$$

To achieve such state, the double optical heralding is configured to exclude all possible quantum states that are not a part of the desired maximally entangled Bell state. For example, the product of two superposition states of two qubits (e.g., Q0 and Q2) is the sum of |0 [symbol] |1 [symbol] , |1 [symbol] |0 [symbol] , |0 [symbol] |0 [symbol] , and |1 [symbol] |1 [symbol] states. The states |0 [symbol] |1 [symbol] and |1 [symbol] |0 [symbol] are part of a maximally entangled Bell state, while the states |0 [symbol] |0 [symbol] and |1 [symbol] |1 [symbol] are not part of the maximally entangled Bell state. A maximally entangled Bell state means that measuring the state of one qubit (e.g., Q0) can be used to completely determine the state of the other qubit (e.g., Q2). For example, if the data qubit Q0 is measured to be in state |0 [symbol] , then the data qubit Q2 is guaranteed to yield state |1 [symbol] , when measured. If the data qubit Q0 is measured to be in state |1 [symbol] , then the data qubit Q2 is guaranteed to yield state |0 [symbol] , when measured.

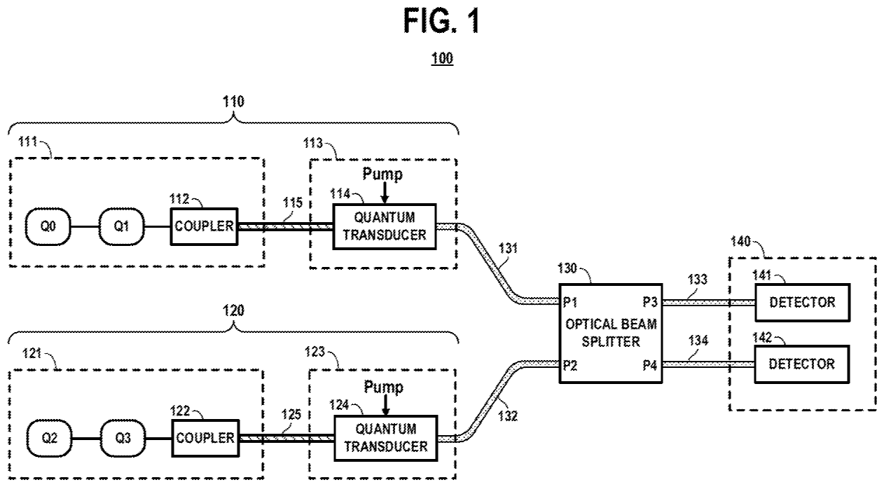

FIG. 1 schematically illustrates a quantum computing system that is configured to implement double optical heralding to enable remote entanglement of quantum bits, according to an exemplary embodiment of the disclosure. In particular, FIG. 1 schematically illustrates a quantum computing system 100 which comprises a first quantum computing system 110, a second quantum computing system 120, an optical beam splitter 130, and a photodetector device 140 (e.g., detector chip). The first quantum computing system 110 comprises a qubit chip 111 (e.g., quantum processor) and a transducer chip 113. The qubit chip 111 comprises a plurality of superconducting quantum bits (e.g., qubits Q0 and Q1), and a coupler 112. The transducer chip 113 comprises a quantum transducer 114. In some embodiments, a superconducting microwave coaxial cable 115 is utilized to connect the coupler 112 to the quantum transducer 114. Similarly, the second quantum computing system 120 comprises a qubit chip 121 (e.g., quantum processor) and a transducer chip 123. The qubit chip 121 comprises a plurality of superconducting quantum bits (e.g., qubits Q2 and Q3), and a coupler 122. The transducer chip 123 comprises a quantum transducer 124, and a superconducting microwave coaxial cable 125 is utilized to connect the coupler 122 to the quantum transducer 124.

The optical beam splitter 130 comprises a plurality of ports P1, P2, P3, and P4. The photodetector device 140 comprises a first detector 141 and a second detector 142. The quantum transducer 114 is optically coupled to the port P1 of the optical beam splitter 130 via an optical fiber cable 131. The quantum transducer 124 is optically coupled to the port P2 of the optical beam splitter 130 via an optical fiber cable 132. The first detector 141 is optically coupled to the port P3 of the optical beam splitter 130 via an optical fiber cable 133. The second detector 142 is optically coupled to the port P4 of the optical beam splitter 130 via an optical fiber cable 134.

In some embodiments, the first quantum computing system 110 and the second quantum computing system 120 are separate quantum systems that are disposed in different dilution refrigeration systems (e.g., cryostats). The photodetector device 140 is disposed in a cryogenic environment. For example, in some embodiments, the photodetector device 140 is disposed in a dilution refrigeration system which is separate from the dilution refrigeration systems which contain the first quantum computing system 110 and the second quantum computing system 120. In other embodiments, the photodetector device 140 is disposed in one of the dilution refrigeration systems which contain the first quantum computing system 110 or the second quantum computing system 120. In some embodiments, the optical beam splitter 130 is disposed in a room temperature environment outside of the dilution refrigeration systems.

The superconducting qubits (e.g., qubits Q0, Q1, Q2, and Q3) of the qubit chips 111 and 121 can be implemented using any type of superconducting qubit architecture. For example, the superconducting qubits Q0, Q1, Q2, and Q3 can be transmon qubits, fluxonium qubits, multimode qubits (e.g., two-junction qubits), or other types of superconducting qubits. The superconducting qubits can be fixed-frequency qubits, or tunable-frequency qubits. While FIG. 1 shows the qubit chips 111 and 121 each having two qubits for ease of illustration and explanation, it is to be understood that the qubit chips 111 and 121 can have any number of superconducting qubits arranged in a given qubit lattice (e.g., a heavy hexagonal qubit lattice, a square qubit lattice, etc.). In addition, some superconducting quits can be utilized as flux-tunable couplers that do not encode quantum information, but which are configured to control/mediate interactions between superconducting quits within the qubit lattice.

In the context of the exemplary double heralded entanglement protocols as discussed herein, the superconducting qubits comprise data qubits and interface qubits. The data qubits are long-lived superconducting qubits which are utilized to store and process quantum information (e.g., microwave photons). The interface qubits are superconducting qubits which are utilized to provide an interface between the data qubits and the quantum transducers. For example, in the exemplary embodiment of FIG. 1, on the qubit chip 111, the qubit Q0 is a data qubit, and the qubit Q1 is an interface qubit. Similarly, on the qubit chip 121, the qubit Q2 is a data qubit, and the qubit Q3 is an interface qubit. The data qubits Q0 and Q2 are coupled to the respective interface qubits Q1 and Q3 via a direct waveguide connection or some other superconducting coupler circuit such as a coplanar resonator. The interface qubits Q1 and Q3 are connected to the respective superconducting microwave coaxial cables 115 and 125 through respective couplers 112 and 122. In some embodiments, the couplers 112 and 122 are configured to transfer the quantum states of the interface qubits Q1 and Q3 to the respective quantum transducers 114 and 124 by modifying the energy of resonant modes of the superconducting microwave coaxial cables 115 and 125 so that such the cables can become in resonance with the interface qubits Q1 and Q3 and the quantum transducers and, thereby enable the state transfer.

As explained in further detail below, to perform an optically heralded entanglement between two data quits (e.g., data qubits Q0 and Q2), the states of the two data qubits are entangled with respective interface qubits (e.g., Q1 and Q3) using, e.g., controlled-NOT gates, and the quantum states (e.g., microwave photons) of the interface qubits are transferred to the quantum transducers. In this instance, the quantum states of the interface qubits are consumed, rather than the quantum states of the data qubits when performing a heralded entanglement process (since the controlled-NOT gates do not result in the consumption of the states of the data qubits).

The first and second quantum transducers 114 and 124, the optical beam splitter 130, and the first and second detectors 141 and 142 collectively implement a system to perform a double optical heralding entanglement operation for remote entanglement of data quantum bits, e.g., data qubits Q0 and Q2. The first quantum transducer 114 and the second quantum transducer 124 are nonlinear devices that are configured to convert a single microwave photon to a single optical photon, and vice versa (alternatively referred to herein as microwave-to-optical (m2o) transducers). For example, in some embodiments, the first and second quantum transducers 114 and 124 are configured to convert a single microwave photon to a single optical photon in the visible or near-infrared energy domains, e.g., in the infrared telecom o-band (1310 nm) and c-band (1550 nm).

As schematically illustrated in FIG. 1, optical pump signals (Pump) are applied to the first quantum transducer 114 and the second quantum transducer 124 to enable operation of the quantum transducers. In some embodiments, the optical pump signals comprise laser light signals that are input to pump control ports of the first and second quantum transducers 114 and 124. In an exemplary embodiment, the first and second quantum transducers 114 and 124 each comprise a “red-detuned” quantum transducer in which the optical pump input has an energy (e.g., frequency) which is lower than the energy (e.g., frequency) of a single microwave photon that is input to the quantum transducer, so that the energy of the input microwave photon added to the energy of the optical pump photon results in the energy of a single optical photon that is output from the quantum transducer. With this “red-detuned” mode of mode of operation, a microwave photon can be upconverted to an optical photon using a three-wave mixing operation. The term x⁽²⁾ denotes a second order nonlinear susceptibility tensor of a material, and such term is used herein to denote a nonlinear optical process that a quantum transducer is configured to perform to enable three-wave mixing.

In some embodiments, the first and second quantum transducers 114 and 124 can be implemented using low transduction efficient quantum transducers. The “transduction efficiency” of a quantum transducer refers to a probability that the quantum transducer will successfully convert an input microwave photon to an optical photon on its output port. An inefficient quantum transducer only generates an optical photon some percentage of time. The heralded entanglement protocols as described herein can be utilized to achieve remote entanglement using low efficiency quantum transducers.

The optical photons output from the first quantum transducer 114 are transmitted via the optical fiber cable 131 and input to the first port P1 of the optical beam splitter 130. Similarly, the optical photons output from the second quantum transducer 124 are transmitted via the optical fiber cable 132 and input to the second port P2 of the optical beam splitter 130. In some embodiments, the optical beam splitter 130 comprises a 50:50 fiber-optic beam splitter which is configured to enable optical photon interference based on the two-photon interference effect known as the Hong-Ou-Mandel effect, before the optical photons reach the photodetector device 140. In particular, due to Hong-Ou-Mandel two-photon interference effect, if two indistinguishable optical photons arrive simultaneously at the optical beam splitter 130 from the first and second quantum transducers 114 and 124, the two optical photons will be directed to the same detector (e.g., first detector 141 or second detector 142). In other words, when two indistinguishable optical photons are input to ports P1 and P2 of the optical beam splitter 130 at essentially the same time, the two optical photons will be output together at port P3 or port P4 of the optical beam splitter 130 (i.e., the two photons have a 50:50 chance of exiting (together) in either output port P3 or P4).

The first detector 141 is configured to detect photons emitted from the port P3 of the optical beam splitter 130, and the second detector 142 is configured to detect photons emitted from port P4 of the optical beam splitter 130. In some embodiments, the first and second detectors 141 and 142 are implemented using superconducting nanowire single-photon detectors which are configured to detect for the presence of photons that are output from ports P3 and P4. The first and second detectors 141 and 142 are not photon number resolving detectors that can detect a number of photons emitted from a given output port. In this regard, when either one or two photons are output from port P3, the first detector 141 will only detect the presence of a single photon. Similarly, when either one or two photons are output from port P4, the second detector 142 will only detect the presence of a single photon. Moreover, when the first detector 141 or the second detector 142 detects an optical photon, it is known that the optical photon was emitted from at least one of the first and second quantum transducers 114 and 124 (e.g., at least one of the quantum transducers 114 and 124 has a state of |1)), but which quantum transducer had been excited is not known. As explained in further detail below, this inherent uncertainty of the path of the photon (“which-path-erasure”) allows the registering of an optical photon by either the first detector 141 or the second detector 142 (a heralding event) to exclude states in which neither the first quantum transducer 114 nor the second quantum transducer 124 was excited, while preserving quantum entanglement between remaining possible qubit states.

The quantum computing system 100 is configured to implement a double optical heralding process to remotely entangle two superconducting qubits (e.g., data qubits Q0 and Q2), in which remote entanglement is heralded by photon interference and detection, where after a successful heralding event, the two remote qubits Q0 and Q2 are in one of their maximally entangled Bell states. A successful heralding event excludes all possible quantum states that are not part of the maximally entangled Bell states. In particular, assuming the state of the two superconducting qubits Q0 and Q2 is represented as |Q0 [symbol] |Q2 [symbol] , a successful Bell state is represented as

$$\frac{1}{\sqrt{2}} ( ( \vert 1 〉 \vert 0 〉 + {e}^{i ϕ} \vert 0 〉 \vert 1 〉 ) ,$$

where ϕ denotes a phase factor.

To generate this state using a “red-detuned” quantum transducer which upconverts a microwave photon to an optical photon, as an initial process, the two superconducting qubits Q0 and Q2 are each individually rotated into a superposition state

$$\vert ψ 〉 = \frac{1}{\sqrt{2}} \vert 1 〉 + \frac{1}{\sqrt{2}} \vert 0 〉 ,$$

and such superposed states are transferred to the first and second quantum transducers 114 and 124, and photon detection (e.g., heralding event) is listened for. The product of these two superpositions is the sum of |0 [symbol] |1 [symbol] , |1 [symbol] |0 [symbol] , |0 [symbol] |0 [symbol] , and |1 [symbol] |1 [symbol] states. The states |0 [symbol] |1 [symbol] and |1 [symbol] |0 [symbol] are part of a desired maximally entangled Bell state, while the states |0 [symbol] |0 [symbol] and |1 [symbol] |1 [symbol] are not part of the desired maximally entangled Bell state.

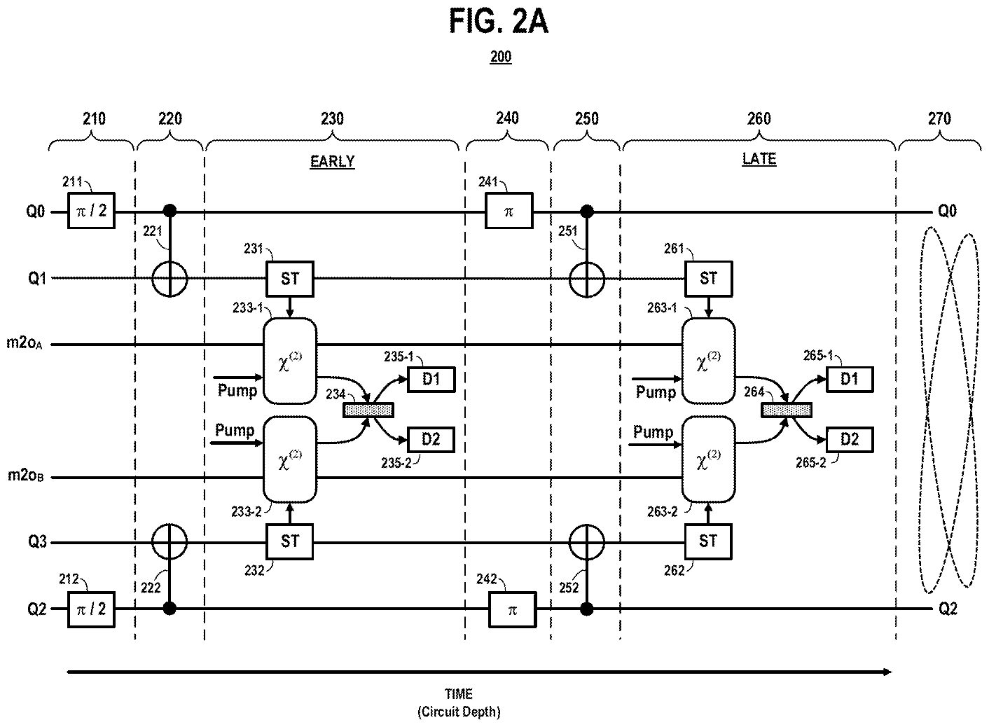

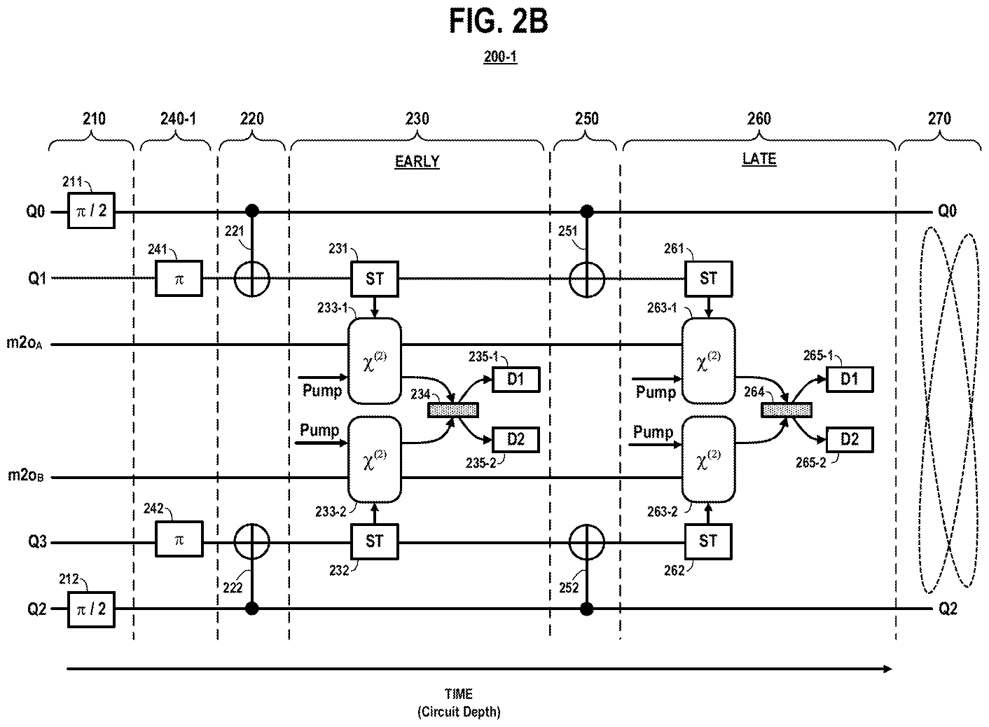

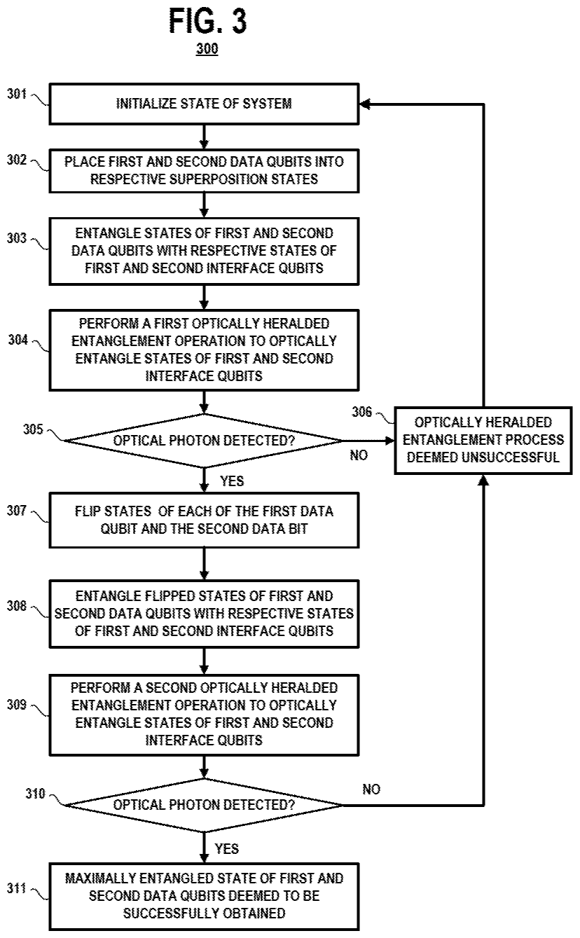

Ideally, an optical heralding process would exclude both states |0 [symbol] |0 [symbol] and |1 [symbol] |1 [symbol] , but a single optical heralding protocol excludes only the |0 [symbol] |0 [symbol] state. In this regard, exemplary embodiments of the disclosure implement a double optical heralding entanglement protocol which performs two optically heralded entanglement operations including (i) a first optically heralded entanglement operation to determine whether the |0 [symbol] |0 [symbol] state is excluded from the entangled state, and (ii) a second optically heralded entanglement operation to determine whether the |1 [symbol] |1 [symbol] state is excluded from the entangled state. By performing a double optical heralding process, both the |0 [symbol] |0 [symbol] and 1 [symbol] |1 [symbol] states can be excluded from the entangled state, thereby allowing a true maximally entangled Bell state to be heralded. A double heralding process can be viewed as comprising an “early” phase and a “late” phase, wherein the double heralding process maps the state of each of the two data qubits to a photon in one of two time bins, “early” or “late.” A successful Bell state is deemed heralded when photons are successfully detected in both the early and late time bins. Exemplary double optical heralding entanglement techniques will now be discussed in further detail in conjunction with FIGS. 2A, 2B, and 3.

In particular, FIG. 2A schematically illustrates a double optical heralding process 200 for remote entanglement of quantum bits, according to an exemplary embodiment of the disclosure. For illustrative purposes, the double optical heralding process 200 of FIG. 2A will be discussed in the context of the exemplary quantum computing system of FIG. 1. In this regard, FIG. 2A schematically illustrates an exemplary double optical heralding process 200 for remote entanglement of the two data qubits Q0 and Q2 bits. The double optical heralding process 200 is schematically represented, in part, by a quantum circuit which shows single-qubit gate operations and two-qubit gate operations that are performed on the data qubits Q0 and Q2, and the interface qubits Q1 and Q3 and in part, by optical heralding operations that are performed using the first and second quantum transducers 114 and 124, the optical beam splitter 130, and the first and second detectors 141 and 142.

In the exemplary embodiment of FIG. 2A, the states of the qubits Q0, Q1, Q2, and Q3 are represented as |Q0 [symbol] , |Q1 [symbol] , |Q2 [symbol] and |Q3 [symbol] , and the states of the first and second quantum transducers 114 and 124 are represented by |m2o_{A} [symbol] and |m2o_{B} [symbol] , respectively, where each of these six states can be in a ground state |0 [symbol] or a first excited state |1 [symbol] . Although the quantum transducers have several degrees of freedom (e.g., microwave, mechanical, and optical degrees of freedom) and would need several variables to complete describe their state, for simplicity, the states of the quantum transducers are represented using a single degree of freedom. In this regard, for purposes of discussion, it is assumed that a given quantum transducer will take an input microwave state and either successfully transduce a photon from that state to the optical domain, thereby outputting an optical photon, or fail to. Thus, if either of the |m2o [symbol] states are |1 [symbol] , then a successful transduction event will lead to a photon being output, which will then cause one of the first and second detectors (denoted D1 and D2 in FIG. 2A) to register a photon. The following description is based on an assumption that the transduction efficiency of the quantum transducers is 100%. However, this high efficiency is not necessary, and a more general analysis without that assumption would be substantially the same.

The exemplary double optical heralding process 200 of FIG. 2A comprises a plurality of stages 210, 220, 230, 240, 250, 260, and 270, which are sequentially performed over time. For the entanglement generation sequence, the system is initialized to a ground state, i.e., the states of the qubits and quantum transducers, |Q0 [symbol] |Q1 [symbol] |m2o_{A} [symbol] |Q2 [symbol] |Q3 [symbol] |m2o_{B} [symbol] , are all initialized to the ground state, |0 [symbol] _{Q0} |0 [symbol] _{Q1} |0 [symbol] _{m2oA} |0 [symbol] _{Q2} |0 [symbol] _{Q3} |0 [symbol] _{m2oB}, or simply |0 [symbol] |0 [symbol] |0 [symbol] |0 [symbol] |0 [symbol] |0 [symbol] .

In stage 210 of the double optical heralding process 200, a single-qubit gate 211 is applied to the data qubit Q0 to place the data qubit Q0 in a superposition state, and a single-qubit gate 212 is applied to the data qubit Q2 to place the data qubit Q2 in a superposition state. In particular, the single-qubit gates 211 and 212 perform π/2 rotations on the respective data qubits. Q0 and Q2 to please each of the data qubits Q0 and Q2 into a superposed state of:

$$\vert ψ 〉 = \frac{1}{\sqrt{2}} ( \vert 0 〉 + \vert 1 〉 ) .$$

For example, in some embodiments, the single-qubit gates 211 and 212 are Hadamard gates. At the completion of stage 210, the system state is:

$$\frac{1}{2} ( ( \vert 0 〉 + \vert 1 〉 ) \vert 0 〉 \vert 0 〉 ) ( ( \vert 0 〉 + \vert 1 〉 ) \vert 0 〉 \vert 0 〉 ) .$$

In stage 210 of the double optical heralding process 200, a two-qubit gate 221 is performed to entangle the data qubit Q0 with the interface qubit Q1, and a two-qubit gate 222 is performed to entangle the data qubit Q2 with the interface qubit Q3. In an exemplary embodiment, the two-qubit gates 221 and 222 are controlled-NOT gates that are performed with the data qubits Q0 and Q2 as control qubits, and the interface qubits Q1 and Q3 as target qubits. A controlled-NOT gate operates to conditionally flip the state of the target qubit based on the state of the control qubit, i.e., the state of the target qubit is flipped when the control qubit has a “1” state. At the completion of stage 220, the system state is:

$$\frac{1}{2} ( ( \vert 0 〉 \vert 0 〉 + \vert 1 〉 \vert 1 〉 ) \vert 0 〉 ) ( ( \vert 0 〉 \vert 0 〉 + \vert 1 〉 \vert 1 〉 ) \vert 0 〉 ) .$$

Next, in stage 230 of the double optical heralding process 200, a first (early) optically heralded entanglement process is performed. Initially, the quantum states of the interface qubits Q1 and Q3 are transferred to the first and second quantum transducers 114 and 124. In FIG. 2A, an operation 231 denotes a state transfer (ST) of the quantum state of the interface qubit Q1 to the first quantum transducer 114 and, similarly, an operation 232 denotes a state transfer (ST) of the quantum state of the interface qubit Q3 to the second quantum transducer 124. The state transfer operations 231 and 232 can be performed using any suitable method (e.g., swap gate operations). As a result of the state transfer operations 231 and 232 (e.g., swap operations Q1↔m2o_{A} and Q2↔m2o_{B}), the system state becomes:

$$\frac{1}{2} ( \vert 0 〉 \vert 0 〉 \vert 0 〉 + \vert 1 〉 \vert 0 〉 \vert 1 〉 ) ( \vert 0 〉 \vert 0 〉 \vert 0 〉 + \vert 1 〉 \vert 0 〉 \vert 1 〉 ) .$$

The first and second quantum transducers 114 and 124 perform nonlinear three wave mixing operations, denoted by quantum transducer operations 233-1 and 233-2, respectively, to upconvert microwave photons to optical photons. For example, if the transferred state of the interface qubit Q1 is |1 [symbol] , the quantum transducer operation 233-1 can generate and output an optical photon. Similarly, if the transferred state of the interface qubit Q3 is |1 [symbol] , the quantum transducer operation 233-2 can generate and output an optical photon. The optical photons (if any) resulting from the quantum transducer operations 233-1 and 233-2 are applied to the 50:50 optical beam splitter 130, which performs a photon interference operation 234 that allows optical photons from the quantum transducers to interfere before they reach the first and second photodetectors D1 and D2.

The first and second photodetectors D1 and D2 perform respective detection operations 235-1 and 235-2 to detect for the presence of optical photons that may or may not be generated by the first and second quantum transducers 114 and 124 as a result performing the respective quantum transducer operations 233-1 and 233-2. If neither of the first and second photodetectors D1 and D2 detects an optical photon, it can be assumed that the states of the data qubits |Q0 [symbol] and |Q1 [symbol] are both |0 [symbol] , which is not desirable. As such, the process is deemed to fail, and is restarted.

On the other hand, when either photodetector D1 or D2 registers a photon, the process knows that the optical photon was emitted from at least one of the first and second quantum transducers 114 and 124 (e.g., at least one of the transducer states |m2o_{A} [symbol] and |m2o_{B} [symbol] was a |1 [symbol] ). However, the process does not know which quantum transducer was excited. If either one of the photodetectors D1 and D2 detects an optical photon, it can be assumed that the states of the data qubits |Q0 [symbol] and |Q1 [symbol] are |0 [symbol] |1 [symbol] , |1 [symbol] |0 [symbol] , and |1 [symbol] |1 [symbol] . This inherent uncertainty of the path of the photon (“which-path-erasure”) allows the registering of a photon by D1 or D2 (a heralding event) to exclude states in which neither quantum transducer 114 or 124 was excited, while preserving quantum entanglement between the remaining possible qubit states.

In particular, as noted above, due to the Hong-Ou-Mandel photon interference effect, if two indistinguishable optical photons arrive simultaneously at the optical beam splitter 130 from the first and second quantum transducers 114 and 124, both photons will be directed to the same photodetector. In this regard, when one of the photodetectors D1 or D2 registers a photon detection, the process will know that the photon was emitted from at least one of the quantum transducers, but not know which quantum transducer was excited. Again, this inherent uncertainty of the path of the photon (“which-path-erasure”) allows the registering of a photon by either photodetector D1 or D2 (a heralding event) to exclude the states in which neither quantum transducer was excited while preserving quantum entanglement between the remaining possible qubit states. This process is known as entanglement swapping, because the entanglement within each data qubit-transducer pair is swapped to the entanglement of the data qubits due to the path uncertainty that arises from the optical beam splitter 130. In other words, entanglement swapping is a process whereby the entanglement of two separately entangled states is transferred to achieve entanglement in one component each from those two originally entangled states. Here, entanglement swapping means that the entanglement of what had been between the two pairs of optical photons and the two qubits now becomes an entanglement between the two pairs of qubits.

For the entanglement swapping to succeed through the optical heralding process, it is desired that the optical heralding process excludes the |0 [symbol] |0 [symbol] and |1 [symbol] |1 [symbol] states of the data qubits Q0 and Q2 so that the data qubits Q0 and Q2 can be in one of the |0 [symbol] |1 [symbol] or |1 [symbol] |0 [symbol] states with a 50 probability and, thereby, achieve a maximally entangled Bell state of:

$${{{{\vert ψ 〉 = \frac{1}{\sqrt{2}} ( \vert 1 〉}_{Q 0} \vert 0 〉}_{Q 2} \pm \vert 0 〉}_{Q 2} \vert 1 〉}_{Q 0} ) or$$

$${{{{\vert ψ 〉 = \frac{1}{\sqrt{2}} ( \vert 1 〉}_{Q 0} \vert 0 〉}_{Q 2} + {e}^{i ϕ} \vert 0 〉}_{Q 2} \vert 1 〉}_{Q 0} ) ,$$

where ϕ denoted phase. As noted above, at the completion of stage 230 (early optical heralding entanglement process), if neither photodetector D1 or D2 detected an optical photon, the process 200 can determine that the unwanted state |0 [symbol] |0 [symbol] exists, and the entanglement process is restarted.

However, at the completion of stage 230 (early optical heralding entanglement process), if one of the photodetectors D1 or D2 detects an optical photon, the double optical heralding process 200 can determine that the unwanted state |0 [symbol] |0 [symbol] has been excluded, but the detection processes 235-1 and 235-2 cannot distinguish between receiving two photons or one photon, since the photodetectors D1 or D2 are not photon number resolving detectors. As such, in response to a photon detection event in stage 230, double optical heralding process 200 cannot exclude the |1 [symbol] |1 [symbol] state of the data qubits Q0 and Q2, which means that the data qubits Q0 and Q2 can be in an entangled state of |0 [symbol] |1 [symbol] , |1 [symbol] |0 [symbol] , and |1 [symbol] |1 [symbol] , which is not a maximally entangled Bell state.

If a photon is detected (an “early click” is heard), then the state |1 [symbol] |0 [symbol] |0 [symbol] |1 [symbol] |0 [symbol] |0 [symbol] can be excluded as a possible state of the system, and the system is deemed to be in one of the three other states. Due to this exclusion, along with the transfer of the photons out of the quantum transducer states |m2o_{A} [symbol] and |m2o_{B} [symbol] states and the preservation of superposition by the optical beam splitter 130, the system is deemed to be in the state:

$$\frac{1}{\sqrt{3}} ( \vert 1 〉 \vert 0 〉 \vert 0 〉 \vert 0 〉 \vert 0 〉 \vert 0 〉 + \vert 0 〉 \vert 0 〉 \vert 0 〉 \vert 1 〉 \vert 0 〉 \vert 0 〉 + \vert 0 〉 \vert 0 〉 \vert 1 〉 \vert 0 〉 \vert 0 〉 \vert 0 〉 ) .$$

The exemplary double optical heralding process 200 then proceeds to perform stages 240, 250, and 250 to determine whether or not the unwanted state |1 [symbol] |1 [symbol] of the data qubits Q0 and Q2 is excluded. In particular, in stage 240 of the double optical heralding process 200, a single-qubit gate 241 is applied to the data qubit Q0 to invert the state of the data qubit Q0, and a single-qubit gate 242 is applied to the data qubit Q2 to invert the state of the data qubit Q2. In an exemplary embodiment, the single-qubit gates 241 and 242 are quantum NOT-gates that perform Tt rotations to flip (invert) the superposition states of the data qubits Q0 and Q2.

With this process, if the data qubits Q0 and Q2 are in the unwanted state |1 [symbol] |1 [symbol] , the single-qubit gates 241 and 242 will flip the state of the data qubits Q0 and Q2 to |0 [symbol] |0 [symbol] . It is to be noted that at the completion of stage 240, the state of the system is:

$$\frac{1}{2} ( \vert 1 〉 \vert 0 〉 \vert 0 〉 \vert 1 〉 \vert 0 〉 \vert 0 〉 + \vert 1 〉 \vert 0 〉 \vert 0 〉 \vert 0 〉 \vert 0 〉 \vert 1 〉 + \vert 0 〉 \vert 0 〉 \vert 1 〉 \vert 1 〉 \vert 0 〉 \vert 0 〉 + \vert 0 〉 \vert 0 〉 \vert 1 〉 \vert 0 〉 \vert 0 〉 \vert 1 〉 )$$

However, as a result of a photon detection event in stage 230 (e.g., the early optical heralding entanglement process stage), the state |1 [symbol] |0 [symbol] |0 [symbol] |1 [symbol] |0 [symbol] |0 [symbol] can be excluded as a possible state of the system. Therefore, at the completion of stage 240, the state of the system can be:

$$\frac{1}{2} ( \vert 1 〉 \vert 0 〉 \vert 0 〉 \vert 0 〉 \vert 0 〉 \vert 1 〉 + \vert 0 〉 \vert 0 〉 \vert 1 〉 \vert 1 〉 \vert 0 〉 \vert 0 〉 + \vert 0 〉 \vert 0 〉 \vert 1 〉 \vert 0 〉 \vert 0 〉 \vert 1 〉 ) .$$

It is to be noted that while stage 240 is shown in FIG. 2A as being performed subsequent to completion of stage 230, the single-qubit gates 241 and 242 can be performed on the data qubits Q0 and Q2 at some point during execution of stage 230.

In stage 250 of the double optical heralding process 200, a two-qubit gate 251 is performed to entangle the data qubit Q0 with the interface qubit Q1, and a two-qubit gate 252 is performed to entangle the data qubit Q2 with the interface qubit Q3. In the exemplary embodiment, the two-qubit gates 251 and 252 are controlled-NOT gates that are performed with the data qubits Q0 and Q2 as control qubits, and the interface qubits Q1 and Q3 as target qubits. Prior to performing stage 250, it is assumed that the states of the interface qubits Q1 and Q3 were reset to ground states by, e.g., being consumed by the initial state transfer (ST) operations 231 and 232. At the completion of stage 250, the system state can be in the following state:

$$\frac{1}{\sqrt{3}} ( \vert 1 〉 \vert 1 〉 \vert 0 〉 \vert 0 〉 \vert 0 〉 \vert 0 〉 + \vert 0 〉 \vert 0 〉 \vert 0 〉 \vert 1 〉 \vert 1 〉 \vert 0 〉 + \vert 0 〉 \vert 0 〉 \vert 0 〉 \vert 0 〉 \vert 0 〉 \vert 0 〉 ) .$$

Next, in stage 260 of the double optical heralding process 200, a second (late) optically heralded entanglement process is performed, which is similar to the first (early) optically heralded entanglement process performed in stage 230. Initially, the quantum states of the interface qubits Q1 and Q3 are transferred to the first and second quantum transducers 114 and 124 via respective state transfer (ST) operations 261 and 262. As a result of the state transfer operations 261 and 232 (e.g., swap operations Q1↔m2o_{A} and Q2↔m2o_{B}), the system state can have the following state:

$$\frac{1}{\sqrt{3}} ( \vert 1 〉 \vert 0 〉 \vert 1 〉 \vert 0 〉 \vert 0 〉 \vert 0 〉 + \vert 0 〉 \vert 0 〉 \vert 0 〉 \vert 1 〉 \vert 0 〉 \vert 1 〉 + \vert 0 〉 \vert 0 〉 \vert 0 〉 \vert 0 〉 \vert 0 〉 \vert 0 〉 ) .$$

The first and second quantum transducers 114 and 124 perform nonlinear three wave mixing operations, denoted by quantum transducer operations 263-1 and 263-2, respectively, to upconvert microwave photons to optical photons. The outputs of the quantum transducer operations 263-1 and 263-2 are applied to the 50:50 beam splitter 130, which performs a second photon interference operation 264 which allows optical photons from the quantum transducers to interfere before they reach the photodetectors D1 and D2.

The photodetectors D1 and D2 perform respective detection operations 265-1 and 265-2 to detect for the presence of optical photons that may or may not be generated by the first and second quantum transducers 114 and 124 as a result performing the respective quantum transducer operations 263-1 and 263-2. If neither of the photodetectors D1 and D2 detects an optical photon as a result of the second (late) optically heralded entanglement process (stage 260), this is an indication that the data qubits |Q0 [symbol] and |Q1 [symbol] have a |1 [symbol] |1 [symbol] , which was converted to a |0 [symbol] |0 [symbol] state by virtue of the state-inverting gates 241 and 242, (stage 240), wherein the |1 [symbol] |1 [symbol] is not desirable. As before, if an optical photon is not detected as a result of the second (late) optically heralded entanglement process (stage 260), the entanglement sequence is deemed to fail and is restarted.

On the other hand, when either photodetector D1 or D2 detects an optical photon as a result of the second (late) optically heralded entanglement process (stage 260), it is assumed that the data qubits |Q0 [symbol] and |Q1 [symbol] have a |0 [symbol] |1 [symbol] or |1 [symbol] |0 [symbol] . Therefore, if a photon is detected (a “late click” is heard) in stage 260, then the process determines (in final stage 270) that the state |0 [symbol] |0 [symbol] |0 [symbol] |0 [symbol] |0 [symbol] |0 [symbol] can be excluded, and the heralding operation thus leaves the system in the state:

$$\frac{1}{\sqrt{2}} ( \vert 1 〉 \vert 0 〉 \vert 0 〉 \vert 0 〉 \vert 0 〉 \vert 0 〉 + \vert 0 〉 \vert 0 〉 \vert 0 〉 \vert 1 〉 \vert 0 〉 \vert 0 〉 ) ,$$

which is the desired maximally entangled Bell state: between data qubits Q0 and Q2. In short, a successful optically heralded entanglement process is deemed to be achieved when a photon detection event is obtained in both the first (early) optically heralded entanglement process (stage 230) and the second (early) optically heralded entanglement process (stage 260).

Next, FIG. 2B schematically illustrates a double optical heralding process 200-1 for remote entanglement of quantum bits, according to another exemplary embodiment of the disclosure. It is to be noted that the double optical heralding process 200-1 of FIG. 2B is similar to the exemplary double optical heralding process 200 of FIG. 2A, except that the process 200-1 of FIG. 2B includes a quantum NOT gate stage (stage 240-1) that is added between stages 210 and 220, and removing the quantum NOT gate stage (stage 240) between stages 230 and 250 (as in FIG. 2A). In the exemplary process 200-1 of FIG. 2B, a single-qubit gate 241 is applied to the interface qubit Q1 to invert the state of the interface qubit Q1, and a single-qubit gate 242 is applied to the interface qubit Q3 to invert the state of the interface qubit Q3. In an exemplary embodiment, the single-qubit gates 241 and 242 are quantum NOT-gates that perform π rotations to flip (invert) the states of the interface qubits Q1 and Q3.

The double optical heralding process 200-1 of FIG. 2B is similar in operation to the double optical heralding process 200 of FIG. 2A, the details of which will not be repeated. In the exemplary process 200-1, the initialized ground states |0 [symbol] |0 [symbol] of the interface qubits Q1 and Q3 are flipped to the states |1 [symbol] |1 [symbol] as a result of the single-qubit gates 241 and 242 performed in stage 240-1. In this regard, when the data qubits Q0 and Q2 have states |1 [symbol] |1 [symbol] , the controlled-NOT gate stage (stage 220) changes the states of the interface qubits Q1 and Q3 from |1 [symbol] |1 [symbol] to |0 [symbol] |0 [symbol] . The |0 [symbol] |0 [symbol] states of the interface qubits Q1 and Q3 are transferred (via ST operations 231 and 232) to the quantum transducer operations 233-1 and 233-2. Consequently, the first optical heralding operation (stage 230) does not result in the detection of an optical photon, thereby resulting in the exclusion of the |1 [symbol] |1 [symbol] state of the data qubits Q0 and Q2.

On the other hand, when the data qubits Q0 and Q2 have states |0 [symbol] |0 [symbol] , the controlled-NOT gate stage (stage 220) does not change the states of the interface qubits Q1 and Q3, so the |1 [symbol] |1 [symbol] states of the interface qubits Q1 and Q3 are transferred (via ST operations 231 and 232 to the quantum transducer operations 233-1 and 233-2. Consequently, the first (early) optical heralding operation (stage 230) can detect an optical photon. Since the |1 [symbol] |1 [symbol] states of the interface qubits Q1 and Q3 are consumed by the ST operations 231 and 232, the resulting |0 [symbol] |0 [symbol] states of the interface qubits Q1 and Q3 are applied to the controlled-NOT gate stage (stage 250). Since the data qubits Q0 and Q2 have states |0 [symbol] |0 [symbol] , the |0 [symbol] |0 [symbol] states of the interface qubits Q1 and Q3 are not changed, and are transferred (via ST operations 261 and 262) to the quantum transducer operations 263-1 and 263-2. Consequently, the second (late) optical heralding operation (stage 260) will not detect an optical photon, thereby resulting in the exclusion of the |0 [symbol] |0 [symbol] state of the data qubits Q0 and Q2.

FIG. 3 illustrates a flow diagram of a double optical heralding process for remote entanglement of quantum bits, according to an exemplary embodiment of the disclosure. In particular, FIG. 3 illustrates a flow diagram of a double optical heralding process 300 for remote entanglement of quantum bits, which is based on the double optical heralding process as schematically illustrated and discussed above in conjunction with FIG. 2A. In this regard, for illustrative purposes, the process flow of FIG. 3 may be discussed in the context of the exemplary embodiments of FIGS. 1 and 2A, for performing a remote entanglement of two data qubits (e.g., Q0 and Q2). As an initial step, the double optical heralding process 300 comprises initializing a system state (bock 301). For example, a system state initialization process generally involves resetting the states of the data qubits (e.g., first and second data qubits Q0 and Q2) to be remotely entangled, the corresponding interface qubits (e.g., first and second interface qubits Q1 and Q3), and the quantum transducers that are to be utilized for converting microwave photons to optical photons.

Next, the double optical heralding process 300 places the first data qubit Q0 and the second data qubit Q2 into respective superposition states (block 302). For example, in some embodiments, a single-qubit gate operation (e.g., π/2 rotation) is individually applied to each of the first data qubit Q0 and the second data qubit Q2 to place both the first data qubit Q0 and the second data qubit Q2 into respective superposition states (block 302). For example, as noted above, in some embodiments, a Hadamard gate operation is individually applied to each of the first data qubit Q0 and the second data qubit Q2 to map the initialized basis state |0 [symbol] to a superposition state:

$$\vert ψ 〉 = \frac{1}{\sqrt{2}} ( \vert 0 〉 + \vert 1 〉 ) ,$$

thus creating an equal superposition of the two computational basis states |0 [symbol] and |1 [symbol] .

The superposed state of the first data qubit Q0 and the superposed state of the second data qubit Q2 are entangled with the state of the first interface qubit Q1 and the state of the second interface qubit Q3, respectively (block 303). For example, as noted above, in some embodiments, the superposed state of a data qubit is entangled with the state of an interface qubit by applying a controlled two-qubit gate (e.g., controlled-NOT gate) that is configured to conditionally flip a state of the interface qubit (target qubit) based on a state of the data qubit (control qubit).

Next, a first optically heralded entanglement operation is performed to optically entangle the quantum states of the first and second interface qubits (block 304). In some embodiments, as noted above, the first optically heralded entanglement operation is performed by a process which comprises, e.g., (i) transferring the quantum states of the first interface qubit Q1 and the second interface qubit Q3 to first and second quantum transducers 114 and 124 to generate and output one or more optical photons (or no optical photons), depending on the quantum states the first and second interface qubits Q1 and Q3, and (ii) performing photon interference (via the optical beam splitter 130) and photon detection (via the first and second detectors 141 and 142). As noted above, the first and second quantum transducers 114 and 124 are configured to upconvert microwave photons to optical photons with a given transduction efficiency (where it is possible that a given quantum transducer may not successfully convert a microwave photon input to an optical photon on its output).

The double optical heralding process 300 proceeds to determine whether an optical photon was detected by at least one of the first and second detectors 141 and 142 (block 305). If no optical photon was detected by either the first detector 141 or the second detector 142 (negative result in block 305), the optically heralded entanglement process is deemed to be unsuccessful (block 306), and the system state is reinitialized (return to block 301) and the double optical heralding process 300 is restarted. In instances where no optical photon is detected as a result of the first optically heralded entanglement operation, assuming 100% transduction efficiency, the unsuccessful detection of an optical photon can mean that the entangled state of the data qubits includes the quantum state |0 [symbol] |0 [symbol] , which needs to be excluded. In other instances, the unsuccessful detection of an optical photon can be the result of a failure of one or both of the first and second detectors 141 and 142 to generate an optical photon despite the presence of an input microwave photon, or a detection failure.

On the other hand, if an optical photon was detected by either the first detector 141 or the second detector 142 (affirmative result in block 305), this provides an indication that the entangled state of the qubits excludes the quantum state |0 [symbol] |0 [symbol] , but may include the desired |0 [symbol] |1 [symbol] and |1 [symbol] |0 [symbol] states, and the undesired |1 [symbol] |1 [symbol] states. In this regard, the double optical heralding process 300 continues to determine if the |1 [symbol] |1 [symbol] is excluded from the entangled state.

For example, to determine if the |1 [symbol] |1 [symbol] is included or excluded from the entangled state, a single-qubit gate operation (e.g., n-rotation) is individually applied to each of the first data qubit Q0 and the second data qubit Q2 to flip (invert) the states of both the first data qubit Q0 and the second data qubit Q2 (block 307). In some embodiments, the states of the first data qubit Q0 and the second data qubit Q2 are flipped by performing a quantum NOT gate operation on each of the first and second data qubits Q0 and Q2. In this instance, if the first and second data qubits Q0 and Q2 are in the state |1 [symbol] |1 [symbol] , the quantum NOT gate operations will flip the first and second data qubits Q0 and Q2 to the state |0 [symbol] |0 [symbol] . On the hand, if the first and second data qubits Q0 and Q2 are in the state |0 [symbol] |1 [symbol] or |1 [symbol] |0 [symbol] , the quantum NOT gate operations will flip the first and second data qubits Q0 and Q2 to the state |1 [symbol] |0 [symbol] or |0 [symbol] |1 [symbol] .

The inverted superposed state of the first data qubit Q0 and the inverted superposed state of the second data qubit Q2 are entangled with the initialized state of the first interface qubit Q1 and the initialized state of the second interface qubit Q3, respectively (block 308). For example, as noted above, the entanglement operations in block 308 are each performed using a controlled two-qubit gate (e.g., controlled-NOT gates) that is configured to conditionally flip the state of the interface qubit (target qubit) based on a state of the data qubit (control qubit).

Next, a second optically heralded entanglement operation is performed to optically entangle the quantum states of the first and second interface qubits (block 309). The second optically heralded entanglement operation is performed in the same manner as the first optically heralded entanglement operation (block 304), by a process which comprises, e.g., (i) transferring the quantum states of the first interface qubit Q1 and the second interface qubit Q3 to the first and second quantum transducers 114 and 124 to generate and output one or more optical photons (or no optical photons), depending on the quantum states the first and second interface qubits Q1 and Q3, and (ii) performing photon interference (via the optical beam splitter 130) and photon detection (via the first and second detectors 141 and 142).

The double optical heralding process 300 proceeds to determine whether an optical photon was detected by at least one of the first and second detectors 141 and 142 (block 310). If no optical photon was detected by either the first detector 141 or the second detector 142 (negative result in block 310), the optically heralded entanglement process is deemed to be unsuccessful (block 306), and the system state is reinitialized (return to block 301) and the double optical heralding process 300 is restarted. In instances where no optical photon is detected as a result of the second optically heralded entanglement operation, assuming 100% transduction efficiency, the unsuccessful detection of an optical photon means that the inverted entangled states of the data qubits Q0 and Q2 is |0 [symbol] |0 [symbol] , which corresponds to the presence of the undesired |1 [symbol] |1 [symbol] state of the entangled data qubits Q0 and Q2. In other instances, the unsuccessful detection of an optical photon can be the result of a failure of one or both of the first and second detectors 141 and 142 to generate an optical photon despite the presence of an input microwave photon, or a detection failure.

On the other hand, if an optical photon was detected by either the first detector 141 or the second detector 142 (affirmative result in block 310) as a result of the second optically heralded entanglement operation, this provides an indication that the entangled state of the qubits excludes the original quantum state |1 [symbol] |1 [symbol] , and will include the desired |0 [symbol] |1 [symbol] and |1 [symbol] |0 [symbol] states. As a result, the success of the first and second optically heralded entanglement operation, the process will determine that both of the undesired states |0 [symbol] |0 [symbol] and |1 [symbol] |1 [symbol] state are excluded in the entangled state of the first and second data qubits, and the desired maximally entangled Bell state of the first and second data qubits Q0 and Q2 is deemed to be successfully obtained (block 311). In other words, by performing the double optical heralding process 300, both the |0 [symbol] |0 [symbol] and 1 [symbol] |1 [symbol] states can be excluded from the entangled state, thereby allowing a true maximally entangled Bell state to be heralded, whereby the first and second data qubits Q0 and Q2 are deemed to be in a |0 [symbol] |1 [symbol] state or |1 [symbol] |0 [symbol] state, with an equal probability (50%).

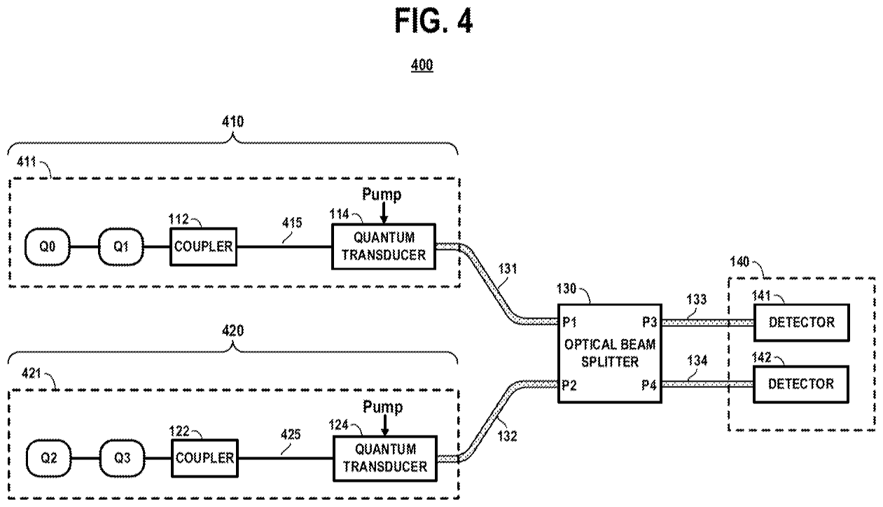

It is to be understood that while exemplary embodiments of a double optical heralding entanglement of remote qubits have been discussed the context of the exemplary quantum computing system 100 of FIG. 1, it is to be understood that quantum computing system architectures can be implemented to perform double optical heralding entanglement of remote qubits. For example, FIG. 4 schematically illustrates a quantum computing system 400 that is configured to implement double optical heralding to enable remote entanglement of quantum bits, according to another exemplary embodiment of the disclosure. The quantum computing system 400 is similar to the quantum computing system 100 of FIG. 1, except that the quantum computing system 400 comprises a first quantum computing system 410 comprising and a second quantum computing system 420, wherein the quantum bits Q0 and Q1, the coupler 112, and the quantum transducer 114 (of the first quantum computing system 410) are disposed on a single chip 411, and wherein the quantum bits Q2 and Q3, the coupler 122, and the quantum transducer 124 (of the second quantum computing system 420) are disposed on a single chip 421. In addition, the couplers 112 and 122 are coupled to the respective first and second quantum transducers 114 and 124 using, e.g., microwave waveguide connections 415 and 525 (instead of the superconducting microwave coaxial cables 115 and 125 as shown in FIG. 1).

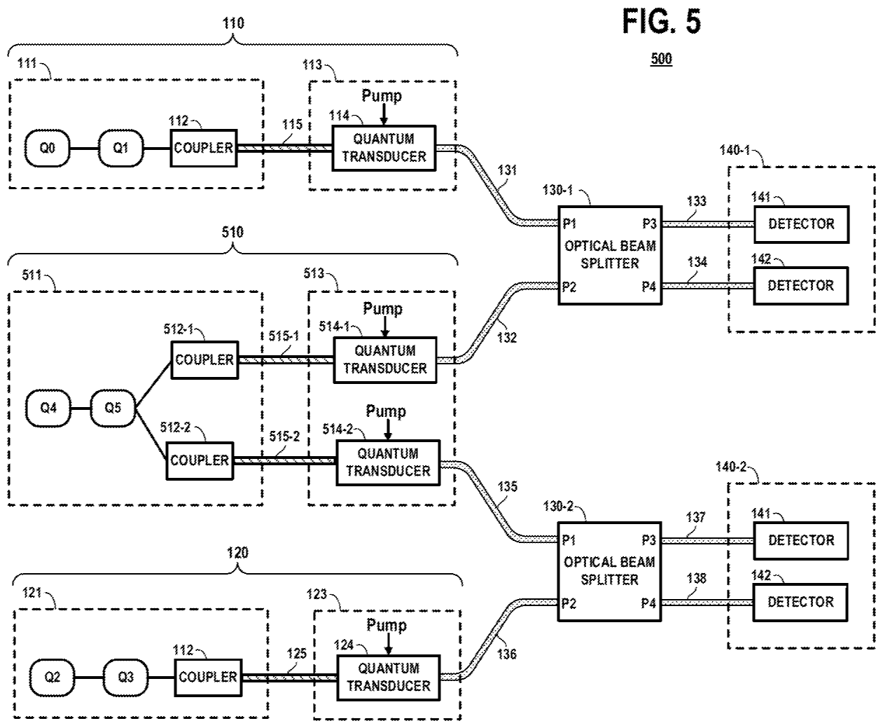

Next, FIG. 5 schematically illustrates a quantum computing system 500 that is configured to implement double optical heralding to enable remote entanglement of quantum bits, according to another exemplary embodiment of the disclosure. The quantum computing system 500 is similar to the quantum computing system 100 of FIG. 1, except that the quantum computing system 400 comprises first and second optical beam splitters 130-1 and 130-2, first and second photon detector devices 140-1 and 140-1, and a third quantum system 510. The third quantum system 510 comprises a qubit chip 511 (e.g., quantum processor) and a transducer chip 513. The qubit chip 511 comprises a plurality of superconducting quantum bits (e.g., data qubit Q4 and interface qubit Q5), and first and second couplers 512-1 and 512-2. The transducer chip 513 comprises first and second quantum transducers 514-1 and 514-2. In some embodiments, the first and second couplers 512-1 and 512-2 are coupled to the first and second quantum transducers 514-1 and 514-2 via respective superconducting microwave coaxial cables 515-1 and 515-2.

In the exemplary configuration of FIG. 5, the first quantum transducers 514-1 is optically coupled to port P2 of the first optical beam splitter 130-1 via the optical fiber cable 132, and the second quantum transducer 514-2 is optically coupled to port P1 of the second optical beam splitter 130-2. The quantum transducer 124 of the second quantum computing system 120 is coupled to port P2 of the second optical beam splitter 130-2. In this regard, FIG. 5 illustrates an exemplary embodiment of how the quantum computing system 100 of FIG. 1 can be scaled to multiple data qubits with multiple quantum transducers. This exemplary architecture enables networks of qubit chips to be daisy chained together.

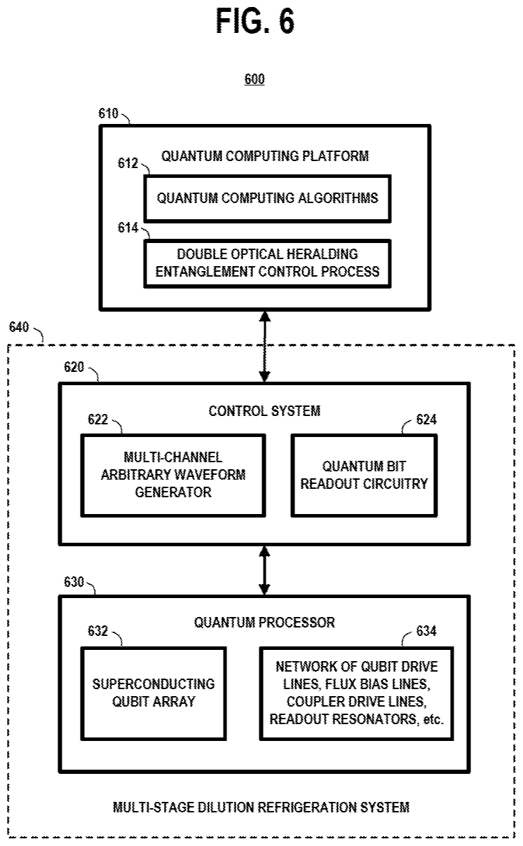

FIG. 6 schematically illustrates a quantum computing system that is configured to implement double optical heralding to enable remote entanglement of quantum bits, according to another exemplary embodiment of the disclosure. In particular, FIG. 6 schematically illustrates a quantum computing system 600 which comprises a quantum computing platform 610, a control system 620, and a quantum processor 630. In some embodiments, the quantum computing platform 610 implements a software platform that is configured to program a quantum computer to execute quantum computing algorithms 612 which are implemented using, e.g., quantum circuits which define computational routings consisting of coherent quantum operations on quantum data, such as qubits. In addition, the quantum computing platform 610 hosts a double optical heralding entanglement control process 614 is configured to control the execution of optically heralded entanglement operations as discussed herein (e.g., FIGS. 2A, 2B, and 3).

In some embodiments, the control system 620 comprises a multi-channel arbitrary waveform generator 622, and a quantum bit readout control system 624. The quantum processor 630 comprises one or more solid-state quantum chips which comprise, e.g., a superconducting qubit array 632 with data qubits, interface qubits, and couplers, etc., as well as network 634 of qubit drive lines, flux-bias control lines, qubit coupler drive lines, qubit state readout resonators, and other circuit QED components that may be needed for a given application or quantum system configuration.

In some embodiments, the control system 620 and the quantum processor 630 are disposed in a dilution refrigeration system 640 which can generate cryogenic temperatures that are sufficient to operate components of the control system 620 for quantum computing applications. For example, the quantum processor 630 may need to be cooled down to near-absolute zero, e.g., 10-15 millikelvin (mK), to allow the superconducting qubits to exhibit quantum behaviors. In some embodiments, the dilution refrigeration system 640 comprises a multi-stage dilution refrigerator where the components of the control system 620 can be maintained at different cryogenic temperatures, as needed. For example, while the quantum processor 630 may need to be cooled down to, e.g., 10-15 mK, the circuit components of the control system 620 may be operated at cryogenic temperatures greater than 10-15 mK (e.g., cryogenic temperatures in a range of 3K-4K), depending on the configuration of the quantum computing system. In some embodiments, the entirety of the control system 620, or some components thereof, are disposed in a room temperature environment.

In some embodiments, the superconducting qubit array 632 comprises a quantum system of superconducting qubits (e.g., data qubits, interface qubits), superconducting qubit couplers, and other components commonly utilized to support quantum processing using qubits. The number of superconducting qubits of the superconducting qubit array 632 can be on the order of tens, hundreds, thousands, or more, etc. The network 634 of qubit drive lines, flux bias control lines, coupler drive lines, and qubit state readout resonators, etc., is configured to apply microwave control signals to superconducting qubits and coupler circuitry in the superconducting qubit array 632 to perform various types of gate operations, e.g., single-gate operations, entanglement gate operations, perform error correction operations, etc., as well as read the quantum states of the superconducting qubits. For example, microwave control pulses are applied to the qubit drive lines of respective superconducting qubits to change the quantum state of the superconducting qubits (e.g., change the quantum state of a given qubit between the ground state and excited state, or to a superposition state) when executing quantum information processing algorithms.

Furthermore, as noted above, the state readout lines comprise readout resonators that are coupled to respective superconducting qubits. The state of a given superconducting qubit can be determined through microwave transmission or reflection measurements using the readout ports of the readout resonator. The states of the superconducting qubits are read out after executing a quantum algorithm. In some embodiments, as noted above, a dispersive readout operation is performed in which a change in the resonant frequency of a given readout resonator, which is coupled to a given superconducting qubit, is utilized to readout the state (e.g., ground or excited state) of the given superconducting qubit.

The network 634 of qubit drive lines, flux bias lines, qubit coupler drive lines, qubit state readout resonators, etc., is coupled to the control system 620 through a suitable hardware input/output (I/O) interface, which couples I/O signals between the control system 620 and the quantum processor 630. For example, the hardware I/O interface may comprise various types of hardware and components, such as RF cables, wiring, RF elements, optical fibers, heat exchanges, filters, amplifiers, isolators, etc.

In some embodiments, the multi-channel arbitrary waveform generator (AWG) 622 and other suitable microwave pulse signal generators are configured to generate the microwave control pulses that are applied to the qubit drive lines, and the coupler drive lines to control the operation of the superconducting qubits and associated qubit coupler circuitry, when performing various gate operations to execute a given certain quantum information processing algorithm. In some embodiments, the multi-channel AWG 622 comprises a plurality of AWG channels, which control respective superconducting qubits within the superconducting qubit array 632 of the quantum processor 630. In some embodiments, each AWG channel comprises a baseband signal generator, a digital-to-analog converter (DAC) stage, a filter stage, a modulation stage, an impedance matching network, and a phase-locked loop system to generate LO signals (e.g., quadrature LO signals LO_I and LO_Q) for the respective modulation stages of the respective AWG channels.

In some embodiments, the multi-channel AWG 622 comprises a quadrature AWG system which is configured to process quadrature signals, wherein a quadrature signal comprises an in-phase (I) signal component, and a quadrature-phase (Q) signal component. In each AWG channel the baseband signal generator is configured to receive baseband data as input (e.g., from the quantum computing platform), and generate digital quadrature signals I and Q which represent the input baseband data. In this process, the baseband data that is input to the baseband signal generator for a given AWG channel is separated into two orthogonal digital components including an in-phase (I) baseband component and a quadrature-phase (Q) baseband component. The baseband signal generator for the given AWG channel will generate the requisite digital quadrature baseband IQ signals which are needed to generate an analog waveform (e.g., sinusoidal voltage waveform) with a target center frequency that is configured to operate or otherwise control a given quantum bit that is coupled to the output of the given AWG channel.

The DAC stage for the given AWG channel is configured to convert a digital baseband signal (e.g., a digital IQ signal output from the baseband signal generator) to an analog baseband signal (e.g., analog baseband signals I(t) and Q(t)) having a baseband frequency. The filter stage for the given AWG channel is configured to filter the IQ analog signal components output from the DAC stage to thereby generate filtered analog IQ signals. The modulation stage for the given AWG channel is configured to perform analog IQ signal modulation (e.g., single-sideband (SSB) modulation) by mixing the filtered analog signals I(t) and Q(t), which are output from the filter stage, with quadrature LO signals (e.g., an in-phase LO signal (LO_I) and a quadrature-phase LO signal (LO_Q)) to generate and output an analog RF signal (e.g., a single-sideband modulated RF output signal). In some embodiments, the quantum bit readout control system 624 is implemented based on the readout circuit architecture as schematically shown in FIG. 6.

The quantum computing platform 610 comprises a software and hardware platform which comprises various software layers that are configured to perform various functions, including, but not limited to, generating and implementing various quantum applications using suitable quantum programming languages, configuring and implementing various quantum gate operations, compiling quantum programs into a quantum assembly language, implementing and utilizing a suitable quantum instruction set architecture (ISA), performing calibration operations to calibrate the quantum circuit elements and gate operations, etc. In addition, the quantum computing platform 610 comprises a hardware architecture of processors, memory, etc., which is configured to control the execution of quantum applications, and interface with the control system 620 to (i) generate digital control signals that are converted to analog microwave control signals by the control system 620, to control operations of the quantum processor 630 when executing a given quantum application, and (ii) to obtain and process digital signals received from the control system 620, which represent the processing results generated by the quantum processor 630 when executing various gate operations for a given quantum application. It is to be understood that in some embodiments, the quantum computing platform 610 and the control system 620 collectively implement a control system that is configured to perform and control the execution of the exemplary double optical heralding processes as described herein to remotely entangle states of superconducting qubits of the quantum processor 630 and superconducting qubits of another quantum processor of a remote quantum computing system (which may the same or similar to the quantum computing system 600 of FIG. 6), which are optically coupled together via fiber optic cables, as schematically shown, for example, in FIGS. 1, 4 and 5.

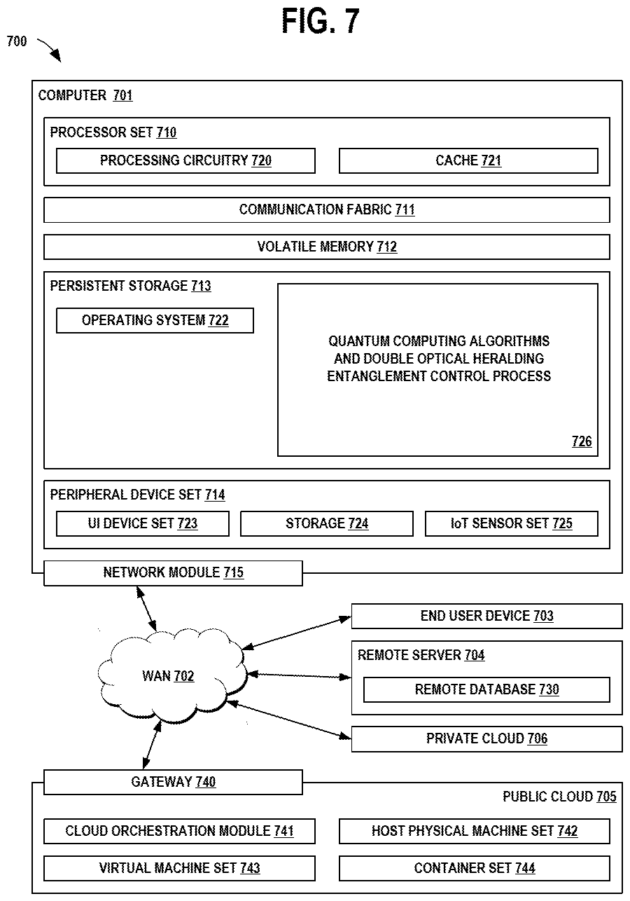

In some exemplary embodiments, the quantum computing platform 610 of the quantum computing system 600 may be implemented using any suitable computing system architecture (e.g., as shown in FIG. 7) which is configured to implement methods to support quantum computing operations and double optical heralding entanglement operations by executing computer readable program instructions that are embodied on a computer program product which includes a computer readable storage medium (or media) having such computer readable program instructions thereon for causing a processor to perform control methods as discussed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 700 of FIG. 7 contains an example of an environment for the execution of at least some of the computer code (block 726) involved in executing quantum computing algorithms and double optical heralding entanglement control processes for remote entanglement of data qubits, as described herein. In addition to block 726, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 726, as identified above), peripheral device set 714 (including user interface (UI), device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

Computer 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

Processor set 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 726 in persistent storage 76.

Communication fabric 711 is the signal conduction paths that allow the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 712 is any type of volatile memory now known or to be developed in the future. Examples include dynamic type random access memory (RAM) or static type RAM. Typically, the volatile memory is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

Persistent storage 76 is any form of non-volatile storage for computers that is now known or to be developed in the future. The non-volatility of this storage means that the stored data is maintained regardless of whether power is being supplied to computer 701 and/or directly to persistent storage 76. Persistent storage 76 may be a read only memory (ROM), but typically at least a portion of the persistent storage allows writing of data, deletion of data and re-writing of data. Some familiar forms of persistent storage include magnetic disks and solid-state storage devices. Operating system 722 may take several forms, such as various known proprietary operating systems or open source Portable Operating System Interface type operating systems that employ a kernel. The code included in block 726 typically includes at least some of the computer code involved in performing the inventive methods.

Peripheral device set 77 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

Network module 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

Remote server 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

Public cloud 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
performing an optically heralded entanglement process to entangle states of a first data quantum bit and a second data quantum bit into an entangled state of computational basis states comprising a ground state and a first excited state, wherein performing the optically heralded entanglement process comprises:
performing a first optically heralded entanglement process to determine whether the entangled state of the first data quantum bit and the second data quantum bit excludes a state in which both the first data quantum bit and the second data quantum bit can be in the ground state; and
performing a second optically heralded entanglement process to determine whether the entangled state of the first data quantum bit and the second data quantum bit excludes a state in which both the first data quantum bit and the second data quantum bit can be in the first excited state.

2. The method of claim 1, wherein performing the optically heralded entanglement process comprises:
performing a single-quantum bit gate operation on each of the first data quantum bit and the second data quantum bit to place the first data quantum bit and the second data quantum bit into respective superposition states; and
performing a controlled two-quantum bit gate operation to conditionally flip a state of a first interface quantum bit based on the superposition state of the first data quantum bit; and
performing a controlled two-quantum bit gate operation to conditionally flip a state of a second interface quantum bit based on the superposition state of the second data quantum bit;
wherein the first optically heralded entanglement process is performed based on the state of the first interface quantum bit and the state of the second interface quantum bit.

3. The method of claim 2, wherein performing the first optically heralded entanglement process comprises:
transferring the state of the first interface quantum bit to a first quantum transducer that is configured to generate an optical photon based on the state of the first interface quantum bit;
transferring the state of the second interface quantum bit to a second quantum transducer that is configured to generate an optical photon based on the state of the second interface quantum bit;
utilizing an optical beam splitter to perform a photon interference based on optical photons output from the first quantum transducer and the second quantum transducer; and
detecting for a presence of an optical photon output from the optical beam splitter, as a result of the first optically heralded entanglement process.

4. The method of claim 3, wherein:
in response to not detecting the presence of an optical photon output from the optical beam splitter as a result of the first optically heralded entanglement process, restarting the optically heralded entanglement process; and
in response to detecting the presence of an optical photon output from the optical beam splitter as a result of the first optically heralded entanglement process, determining that the entangled states of the first data quantum bit and the second data quantum bit exclude the state in which both the first data quantum bit and the second data quantum bit can be in the ground state.

5. The method of claim 4, wherein performing the optically heralded entanglement process comprises:
in response to determining that the entangled states of the first data quantum bit and the second data quantum bit exclude the state in which both the first data quantum bit and the second data quantum bit can be in the ground state:
performing a single-quantum bit gate operation on each of the first data quantum bit and the second data quantum bit to flip the superposition state of the first data quantum bit and to flip the superposition state the second data quantum bit;
performing a controlled two-quantum bit gate operation to conditionally flip a state of the first interface quantum bit based on the flipped superposition state of the first data quantum bit; and
performing a controlled two-quantum bit gate operation to conditionally flip a state of the second interface quantum bit based on the flipped superposition state of the second data quantum bit;
wherein the second optically heralded entanglement process is performed based on the state of the first interface quantum bit and the state of the second interface quantum bit.

6. The method of claim 5, wherein performing the second optically heralded entanglement process comprises:
transferring the state of the first interface quantum bit to the first quantum transducer;
transferring the state of the second interface quantum bit to the second quantum transducer;
utilizing the optical beam splitter to perform a photon interference based on optical photons output from the first quantum transducer and the second quantum transducer; and
detecting for a presence of an optical photon output from the optical beam splitter, as a result of the second optically heralded entanglement process.

7. The method of claim 6, wherein:
in response to not detecting the presence of an optical photon output from the optical beam splitter as a result of the second optically heralded entanglement process, restarting the optically heralded entanglement process; and
in response to detecting the presence of an optical photon output from the optical beam splitter as a result of the second optically heralded entanglement process, determining that the entangled states of the first data quantum bit and the second data quantum bit exclude the state in which both the first data quantum bit and the second data quantum bit can be in the first excited state.

8. The method of claim 1, wherein the optically heralded entanglement process is configured to entangle the states of the first data quantum bit and the second data quantum bit into a maximally entangled Bell state represented by 1/√2((|1 [symbol] |0 [symbol] +e\hat{ }iϕ|0 [symbol] |1 [symbol] ).

9. A system, comprising:
a first quantum system comprising a first data quantum bit;
a second quantum system comprising a second data quantum bit; and
a control system configured to perform an optically heralded entanglement process to entangle states of the first data quantum bit and the second data quantum bit into an entangled state of computational basis states comprising a ground state and a first excited state, wherein in performing the optically heralded entanglement process, the control system is configured to:
perform a first optically heralded entanglement process to determine whether the entangled state of the first data quantum bit and the second data quantum bit excludes a state in which both the first data quantum bit and the second data quantum bit can be in the ground state; and
perform a second optically heralded entanglement process to determine whether the entangled state of the first data quantum bit and the second data quantum bit excludes a state in which both the first data quantum bit and the second data quantum bit can be in the first excited state.

10. The system of claim 9, wherein in performing the optically heralded entanglement process, the control system is configured to:
perform a single-quantum bit gate operation on each of the first data quantum bit and the second data quantum bit to place the first data quantum bit and the second data quantum bit into respective superposition states; and
perform a controlled two-quantum bit gate operation to conditionally flip a state of a first interface quantum bit based on the superposition state of the first data quantum bit; and
perform a controlled two-quantum bit gate operation to conditionally flip a state of a second interface quantum bit based on the superposition state of the second data quantum bit;
wherein the control system performs the first optically heralded entanglement process based on the state of the first interface quantum bit and the state of the second interface quantum bit.

11. The system of claim 10, wherein in performing the first optically heralded entanglement process, the control system is configured to:
transfer the state of the first interface quantum bit to a first quantum transducer that is configured to generate an optical photon based on the state of the first interface quantum bit;
transfer the state of the second interface quantum bit to a second quantum transducer that is configured to generate an optical photon based on the state of the second interface quantum bit;
utilize an optical beam splitter to perform a photon interference based on optical photons output from the first quantum transducer and the second quantum transducer; and
utilize a photon detector device to detect for a presence of an optical photon output from the optical beam splitter, as a result of the first optically heralded entanglement process.

12. The system of claim 11, wherein:
in response to not detecting the presence of an optical photon output from the optical beam splitter as a result of the first optically heralded entanglement process, the control system restarts the optically heralded entanglement process; and
in response to detecting the presence of an optical photon output from the optical beam splitter as a result of the first optically heralded entanglement process, the control system determines that the entangled states of the first data quantum bit and the second data quantum bit exclude the state in which both the first data quantum bit and the second data quantum bit can be in the ground state.

13. The system of claim 12, wherein in performing the optically heralded entanglement process, and in response to determining that the entangled states of the first data quantum bit and the second data quantum bit exclude the state in which both the first data quantum bit and the second data quantum bit can be in the ground state, the control system is configured to:
perform a single-quantum bit gate operation on each of the first data quantum bit and the second data quantum bit to flip the superposition state of the first data quantum bit and to flip the superposition state the second data quantum bit;
perform a controlled two-quantum bit gate operation to conditionally flip a state of the first interface quantum bit based on the flipped superposition state of the first data quantum bit; and
perform a controlled two-quantum bit gate operation to conditionally flip a state of the second interface quantum bit based on the flipped superposition state of the second data quantum bit;
wherein the control system performs the second optically heralded entanglement process based on the state of the first interface quantum bit and the state of the second interface quantum bit.

14. The system of claim 13, wherein in performing the second optically heralded entanglement process, the control system is configured to:
transfer the state of the first interface quantum bit to the first quantum transducer;
transfer the state of the second interface quantum bit to the second quantum transducer;
utilize the optical beam splitter to perform a photon interference based on optical photons output from the first quantum transducer and the second quantum transducer; and
utilize the photodetector device to detect for a presence of an optical photon output from the optical beam splitter, as a result of the second optically heralded entanglement process.

15. The system of claim 14, wherein:
in response to not detecting the presence of an optical photon output from the optical beam splitter as a result of the second optically heralded entanglement process, the control system restarts the optically heralded entanglement process; and
in response to detecting the presence of an optical photon output from the optical beam splitter as a result of the second optically heralded entanglement process, the control system determines that the entangled states of the first data quantum bit and the second data quantum bit exclude the state in which both the first data quantum bit and the second data quantum bit can be in the first excited state.

16. The system of claim 9, wherein the optically heralded entanglement process is configured to entangle the states of the first data quantum bit and the second data quantum bit into a maximally entangled Bell state represented by 1/√2((|1 [symbol] |0 [symbol] +e\hat{ }iϕ|0 [symbol] |1 [symbol] ).

17. A system, comprising:
a first quantum system comprising a first data quantum bit, a first interface quantum bit coupled to the first data quantum bit, and a first quantum transducer coupled to the first interface quantum bit;
a second quantum system comprising a second data quantum bit, a second interface quantum bit coupled to the second data quantum bit, and a second quantum transducer coupled to the second interface quantum bit;
an optical beam splitter having input ports that are optically coupled to respective output ports of the first quantum transducer and the second quantum transducer;
a photon detector device coupled to output ports of the optical beam splitter; and
a control system configured to perform an optically heralded entanglement process to entangle states of the first data quantum bit and the second data quantum bit into an entangled state of computational basis states comprising a ground state and a first excited state, wherein in performing the optically heralded entanglement process, the control system is configured to:
utilize the first and second interface quantum bits, the first and second quantum transducers, the optical beam splitter, and the photon detector device to perform a first optically heralded entanglement process to determine whether the entangled state of the first data quantum bit and the second data quantum bit excludes a state in which both the first data quantum bit and the second data quantum bit can be in the ground state; and
utilize the first and second interface quantum bits, the first and second quantum transducers, the optical beam splitter, and the photon detector device to perform a second optically heralded entanglement process to determine whether the entangled state of the first data quantum bit and the second data quantum bit excludes a state in which both the first data quantum bit and the second data quantum bit can be in the first excited state.

18. The system of claim 17, wherein when performing the optically heralded entanglement process:
a state of the first interface quantum bit is entangled with a state of the first data quantum bit, and the state of the first interface quantum bit is consumed by the first quantum transducer to generate an optical photon that represents a state of the first data quantum bit; and
a state of the second interface quantum bit is entangled with a state of the second data quantum bit, and the state of the second interface quantum bit is consumed by the second quantum transducer to generate an optical photon that represents a state of the second data quantum bit.

19. The system of claim 17, wherein:
the first quantum system is disposed in a first dilution refrigerator;
the second quantum system is disposed in a second dilution refrigerator; and
the optical beam splitter is disposed in a room temperature environment, and optically coupled to the first and second quantum system by optical fiber cables;
the photon detector device is disposed in a cryogenic environment, and optically coupled to the optical beam splitter by optical fiber cables.

20. The system of claim 17, further comprising:
a third quantum system comprising a third data quantum bit, a third interface quantum bit coupled to the third data quantum bit, and a third quantum transducer coupled to the third interface quantum bit;
a second optical beam splitter; and
a second photon detector device coupled to output ports of the second optical beam splitter;
wherein the second quantum system comprises a fourth quantum transducer coupled to the second interface quantum bit;
wherein the second optical beam splitter comprises input ports that are optically coupled to respective output ports of the third quantum transducer and the fourth quantum transducer.
